(19) United States
(12) Patent Application Publication
(10) Pub. No.: US 2026/0302874 A1
(43) Pub. Date: Oct. 1, 2026

(54) Cable Bushing

(71) Applicant: KSB SE & Co. KGaA, Frankenthal (DE)

(72) Inventors: Patrick HAUCK, Frankenthal (DE); Robert MEYER, Frankenthal (DE); Stefan OLTMANN, Frankenthal (DE)

(21) Appl. No.: 19/479,080

(22) PCT Filed: Apr. 25, 2024
(86) PCT No.: PCT/EP2024/061429

§ 371 Date: Oct. 27, 2025

(30) Foreign Application Priority Data
Apr. 28, 2023 (DE) 10 2023 111 033.0

(51) Int. Cl. H02K 5/22; F04D 13/06; H02K 5/12

(52) U.S. Cl. CPC H02K 5/22; F04D 13/06; H02K 5/12

(57) ABSTRACT

An apparatus includes a pump unit with a pump which is driven by a wet-rotor motor. The wet-rotor motor is surrounded by a motor housing and has a stator winding. The motor housing has a bushing arrangement for supplying power to the stator winding of the wet-rotor motor, and the bushing arrangement has, on a part of the motor housing, openings into which in each case one cable bushing is fixed with the aid of a holding element. Each cable bushing has a guide body and an insulating body. The guide body and the stator winding have a connection. The connection is formed as a press connection.

### CROSS REFERENCE TO RELATED APPLICATION

This application is a 371 National Stage Application of PCT/EP2024/061429, filed Apr. 25, 2024, which claims priority from German Patent Application No. 102023111033.0, filed Apr. 28, 2023, the entire disclosure of which is herein expressly incorporated by reference.

### BACKGROUND

The disclosure relates to a pump unit with a pump driven by a wet-rotor motor, wherein the wet-rotor motor is surrounded by a motor housing and a stator winding, wherein the motor housing comprises a bushing arrangement for supplying power to the stator winding of the wet-rotor motor, and the bushing arrangement has, on a part of the motor housing, openings, in each of which a cable bushing is arranged fixedly by means of a holding element, wherein the cable bushing has in each case one guide body and one insulating body.

Such a pump unit can be used, for example, in power plant construction. The housing parts form the pressure cover which delimits an interior space with respect to a surrounding atmosphere. The pressure cover is usually designed for a very high system pressure.

An exemplary device is described in EP 1 910 685 B1. The device comprises a pump which is driven by a fluid-filled motor. The motor has a housing which is part of the pressure cover.

The circulating pumps without shaft seals are also known as stuffing box-free circulation pumps and are often vertical pumps which are driven by wet-rotor motors with or without a split cage.

A wet-rotor motor is usually an asynchronous squirrel-cage motor, the rotor and bearing of which are operated in the conveying medium. Wet-rotor motors require special attention during design, assembly and commissioning, in order that their motor interiors are reliably filled and vented and solid objects in the conveying medium are kept away from the liquid-lubricated plain bearings.

The pump and the electric motor are located here in a common, pressure-resistant housing with a heat barrier between the pump and motor parts. The heat barrier can be configured as an active or passive component and allows temperatures of the conveying medium up to 420° C. The bearings are lubricated by the conveying medium and, moreover, no dynamic seal is required.

The wet-rotor motor is completely filled with fluid. With the rotor and its bearing, the stator and the winding, including the supply line connections, also lie in the fluid. A prerequisite is a water-resistant and pressure-tight insulation of all live parts. The wet-rotor motor is used as a drive motor for stuffing box-free circulating pumps in conventional power plants.

In conventional bushing arrangements for supplying power to wet-rotor motors, the insulation can be constructed in two parts. It consists of an inner insulating body and an outer insulating body.

U.S. Pat. No. 3,043,903 A discloses a bushing arrangement which comprises a single insulating body enclosing a conductor.

JP S55 15968 U describes an insulating element which is attached to a cable and is routed through a cable bushing opening of an electrical device main body. A flange-like projection is formed in a portion of the insulating element, which abuts a shoulder formed in the device main body and is fixed by means of a fastening sleeve.

In known bushing arrangements, the inner insulating body forms the pressure-bearing part. An outer insulating body is arranged over the inner insulating body. In combination, the two insulating bodies require a very long overlap to achieve the necessary creepage distances. This increases the installation space. Metal rings are used for protection in the case of high loads. These require additional sealing points and can be heated by eddy currents.

DE 10 2014 209 517 A1 discloses a device with a pump driven by a wet-rotor motor. The device has a housing comprising a bushing arrangement for supplying power to the wet-rotor motor. The bushing arrangement comprises a cable element and an insulating body. The bushing arrangement comprises a power transmission element.

The weak points of a cable bushing for a wet-rotor motor, which is, in particular, under high fluid pressure, are the sealing against the ambient pressure and the rupture protection in the event of an accident.

### SUMMARY

It is an object of the disclosure to provide a pump unit with a pump and with a cable bushing, which is very compact in design. In addition, the cable bushing should ensure a high degree of safety and take up the smallest possible installation space. As few sealing points as possible should be required.

According to the disclosure, this object is achieved by a pump unit with a pump having the features of the claims. Preferred variants can be gathered from the further independent main claims, the dependent claims, the description and the drawings.

According to the disclosure, the guide body and the stator winding have a connection, wherein the connection is formed as a press joint.

A press joint is a joint between two parts that takes advantage of the friction between these two parts. Press joints belong to the non-positive connections used in joining techniques and are standardized in accordance with DIN 8593.

Preferably, each guide body has a connection to a plastic-insulated conducting wire of the stator winding of the wet-rotor motor. In one favorable variant of the disclosure, the connection is formed as a press joint.

In one advantageous variant of the disclosure, the guide body has an extension which is formed as a hollow cylinder.

Ideally, the cable wire of the stator winding has at least one wire end, which is inserted into the hollow cylinder. The wire end of the plastic-insulated conducting wire is insulated here with PE insulation up to the piece inserted into the hollow cylinder.

Advantageously, the hollow cylinder of the guide body and the wire end of the cable wire of the stator winding have a non-positive connection.

In one particularly favorable variant, the connection, in particular the press joint, is designed as a crimp connection.

Crimping is understood to be a joining process, in which two components are connected together by plastic deformation, for example by flanging, crushing, crimping or folding. A crimp connection is only semi-releasable and, in the case of repairs, can be replaced only with a suitable tool.

When crimping is carried out correctly, a gas-tight connection is created. By deforming the crimp sleeve in the form of the hollow cylinder extension of the guide body and the conducting wire, a structure is created that is largely sealed off from oxygen and is thus largely protected from corrosion on the inside.

Ideally, the conducting wire and the extension of the guide body are made of the same material, preferably of copper. Copper is an almost ideal conductor, in particular for use in wet-rotor motors. The copper-based crimp connection provides excellent and almost loss-free conductivity.

Advantageously, the hollow cylindrical extension of the guide body is an ideally integrated connecting bolt which is designed in one piece with the guide body. This means that no additional component is required, which saves further assembly effort and prevents cable losses due to the use of another component. The crimp connection between the conducting wire and the guide body is advantageously realized directly.

Preferably, the cylindrical connecting or winding wire in the form of the conducting wire is inserted directly into the cylindrical cavity of the extension below the double cone of the guide body and is non-positively connected in an ideally conducting manner.

Compared to known cable bushings for wet-rotor motors, no hard soldering is required. This avoids excessive heat input into the connection, which means that no load on the conductive connection and no aging of the insulation can occur. Furthermore, the solder, which is not always ideally conducting, can be dispensed with.

In one advantageous variant of the disclosure, the connection comprises at least partially at least four, preferably at least six outer surfaces, wherein in each case two outer surfaces are arranged opposite each other. The crimp connection deforms the cylindrical extension of the guide body preferably into a hexagonal body, whereby the inserted cylindrical conducting wire is fixed in the extension of the guide body in a non-positive manner.

Preferably, the connection and the guide body are covered up to at least the insulating body with a shrink fit tube.

In one advantageous variant of the disclosure, the insulating body has at least partially conical surfaces which interact with the guide body.

A cone is a geometrical body that is created when all the points of a planar, bounded and contiguous surface piece are connected in a straight line to a point outside the plane. In the special case of the circular surface piece, the body is also called a circular cone. If the axis is perpendicular to the base plane, this is a straight circular cone.

Ideally, the conical surfaces of the insulating body are formed as partial surfaces of a straight circular cone.

Preferably, the guide body has at least partially conical surfaces. In one particularly advantageous variant of the disclosure, the conical surfaces of the guide body are formed as partial surfaces of a straight circular cone.

Advantageously, the conical surfaces of the guide body interact with the conical surfaces of the insulating body. In one particularly advantageous variant of the disclosure, the conical surfaces of the guide body are formed with the conical surfaces of the insulating body as an active surface pair corresponding to each other.

Preferably, the guide body comprises a rod-shaped part and a part in the form of a double cone. The guide body is preferably formed as an elongate, largely cylindrical rod, at the end of which the connection to the conducting wire of the stator winding is arranged. Advantageously, a thickened portion in the form of a double cone is formed at the end of the guide body and before the connection to the conducting wire, which double cone forms the conical surfaces of the guide body.

Ideally, the insulating body is formed in a manner shrunk fit onto the guide body. Here, the shrinkable composite extends as far as possible over the length of the rod-shaped part of the guide body and ends at the transition to the double cone. Here, the conical surfaces of the insulating body and the conical surfaces of the guide body form a particularly stable end piece of the shrinkable composite. Ideally, the insulating body is subjected to significantly less mechanical stress due to shrink fitting on the double cone and is therefore also more durable in operation.

In addition, shrink fitting the insulating body onto the guide body offers advantageous anti-twist protection, especially in comparison to previous adhesively bonded connections.

Ideally, the conical surfaces of the insulating body interact with the conical surfaces of the guide body. This interaction is initiated by shrink fitting the insulating body onto the guide body. In addition, a sealing O-ring is embedded in the guide body at the transition of the conical surfaces, with the result that there is redundant protection against fluid leakage, should the conical surfaces of the insulating body suffer damage to the connection on the conical surfaces of the guide body.

Advantageously, a thickened portion in the form of a double cone is formed at the end of the guide body and before the connection to the conducting wire, which double cone forms the conical surfaces of the guide body. This double cone provides advantageous rupture or puncture protection for the cable bushing.

In one particularly advantageous variant of the disclosure, the insulating body is formed from a high performance plastic. High performance plastics are a subgroup of thermoplastics which advantageously differ from engineering plastics and standard plastics, in particular in terms of their temperature resistance, but also in terms of chemical resistance and mechanical properties.

In one particularly advantageous variant of the disclosure, the insulating body is formed from polyether ether ketone (PEEK).

Polyether ether ketone is a high temperature-resistant thermoplastic and belongs to the group of substances of polyaryl ether ketones. Its melting temperature is 335° C. PEEK is resistant to almost all organic and inorganic chemicals, highly energetic electromagnetic waves such as gamma rays, X-rays and up to approximately 280° C. also to hydrolysis. PEEK is preferably used in high voltage technology as an insulating material because of its good electrical insulating resistance and low dielectric loss factor.

Preferably, the insulating body has an elongate shape with an internal cylindrical cavity. The guide body is inserted into the cavity, and the insulating body is shrink fitted onto the guide body. A thickened portion is preferably arranged in the central part of the insulating body, which thickened portion is formed as the seat of the cable bushing for the opening of the housing. To this end, the thickened portion has, in the direction of the opening of the housing, a first recess for the implementation of an O-ring, which takes over the task of sealing the cable bushing in the opening of the housing.

In addition, the thickened portion of the insulating body has a further recess in the middle of the thickened portion, into which a further O-ring for sealing can be implemented. This second O-ring is advantageously provided as a redundant seal of the cable bushing in the opening of the housing. In an unfavorable emergency, in which the very high pressure is also accompanied by an increased temperature, after the loss of the sealing effect of the first O-ring, another O-ring can maintain the sealing effect. To this end, the placement of the second O-ring is designed in such a way that there is no direct contact at first, and in the event of damage to the first O-ring, there is no heavy contact with a hot liquid.

Furthermore, the thickened portion on the side facing away from the O-ring has a seat for a ring, which is designed as a rupture protection means. This ring can ideally be designed as a metal ring, wherein the metallic material, for example brass or iron, is not of magnetic configuration. In addition, high temperature-resistant plastics are also suitable. In the case of a so-called rupture, i.e. the insulating body breaks and the guide body is pressed out of the cable bushing, the ring for the rupture protection in combination with the double conical part of the guide body prevent an actual rupture or puncture and advantageously seal the fluid pressure present in the wet-rotor motor.

In one favorable variant of the disclosure, the insulating body has a metallization.

To this end, the metallization is preferably configured in the form of a substituted nickel layer, which realizes a reproducible conductivity by way of a defined layer thickness. The nickel layer is preferably applied in the inner hollow cylinder of the insulating body. This represents an enormous improvement in reproducible conductivity, especially in comparison to otherwise known, manually applied conductive lacquers.

The combination of shrink fitting of the insulating body and metallization of the inner side of the insulating body achieves a free-play and air-free contact between the guide body and the insulating body. This means that a partial discharge due to the design of the cable bushing is particularly effectively avoided or significantly reduced.

In comparison to known cable bushings, the inventive cable bushing requires neither a sealing tape nor a conductive lacquer and also no adhesive, whereby an extremely robust connection between the guide body and insulating body can be achieved, which also has an improved field control characteristic.

Ideally, the cable bushing has a field control lacquer. In one favorable variant of the disclosure, the cable bushing has a field control element, whereby the maximum field strengths are significantly reduced and at the same time the partial discharge inception voltage can be increased.

The so-called field control comprises all measures that are used to reduce local electrical field strengths to such an extent that the electrical strengths of the insulating materials and the interfaces are not exceeded at any point.

For example, the field control lacquer or the field control element has a significantly increased dielectric constant compared to the insulating body, whereby a targeted reduction of the original field strength can be achieved.

In one favorable variant of the disclosure, the cable bushing has a further, outer insulating body. Preferably, the further, outer insulating body is positioned over the shrink fitted insulating body and within the non-magnetic threaded bushing, which fixes the cable bushing in the opening of the housing. In addition, the outer insulating body can be adjusted at the upper end by way of a fixing element. Preferably, the threaded bushing is designed as an M64 external thread.

In one favorable variant of the disclosure, the bushing arrangement comprises three cable bushings. In one alternative variant, six cable bushings can also be realized in a single bushing arrangement.

According to the disclosure, a pump unit with a pump driven by a wet-rotor motor, wherein a bushing arrangement for supplying power to the wet-rotor motor comprises at least one cable bushing, which has a guide body and an insulating body, is produced in a method, in which the insulating body is shrink fitted onto the guide body and a wire end of the stator winding is inserted into the hollow cylinder of the guide body for each cable bushing and a positively locking connection is established using a pressing tool.

According to the disclosure, a pump unit with a pump is used in a power plant circuit with high system pressure to seal the power supply of the wet-rotor motor against high system pressure with the aid of cable bushings.

Further features and advantages of the disclosure will become apparent from the description of exemplary embodiments with reference to the drawings and from the drawings themselves. In the drawings:

### BRIEF DESCRIPTION OF THE DRAWINGS

FIG. 1 is a cross-sectional illustration of a motor-pump unit;

FIG. 2 is a perspective illustration of a bushing arrangement;

FIG. 3 is a sectional illustration of the bushing arrangement;

FIG. 4 is a cross-sectional illustration of the cable bushing; and

FIG. 5 shows a detailed illustration of the cable bushing.

### DETAILED DESCRIPTION

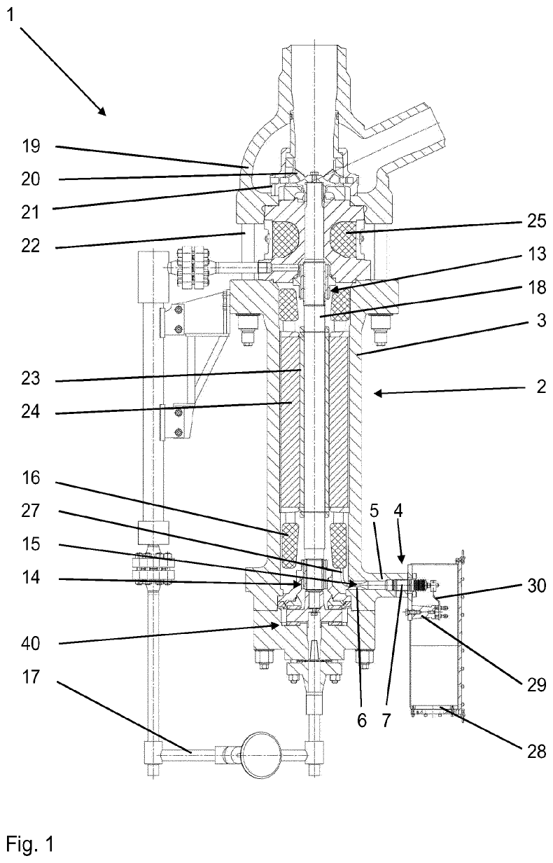

FIG. 1 shows a motor-pump unit with a wet-rotor motor 2. A motor housing 3 forms a part of the pressure cover. The interior of the wet-rotor motor 2 is filled with liquid and has a heat barrier 25. A cooling system 17 is provided to dissipate the electrical power loss. The wet-rotor motor 2 comprises two radial bearings 13, 14 and an axial bearing 40.

The drive power of the wet-rotor motor 2 acts on a shaft train 18 and thus transmits a torque to a pump 1. The pump 1 comprises a pump housing 19, in which an impeller 20 and a guide device 21 are arranged. The pump housing 19 is connected to the motor housing 3 via at least four tie rods 22.

The motor housing 3 and the pump housing 19 together form the pressure cover. This is designed for a high system pressure.

The wet-rotor motor 2 shown in the exemplary embodiment is completely filled with liquid. With the rotor 23 and its bearing, the stator winding 24 and the stator winding head 16, including the supply line connections, also lie in the liquid. For the power supply of the wet-rotor motor 2, a bushing arrangement 4 is provided in the motor housing 3. To this end, the plastic-insulated copper wires 27, which in this design variant have a PE insulation, are connected from the multi-layer coils of the stator winding 24 to the cable bushings 7 with the aid of a connection 15.

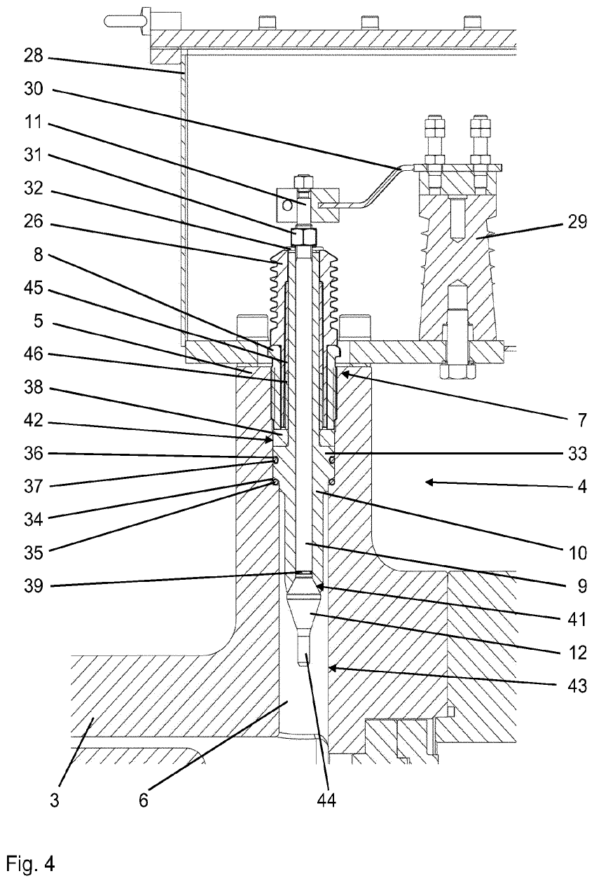

The bushing arrangement 4 comprises a part 5 which is formed by a collar-shaped elevation. The part 5 is formed in one piece with the motor housing 3, whereby even high fluid pressures can be withstood. The part 5 of the motor housing 3 has openings 6, in each of which a cable bushing 7 is arranged. The number of openings 6 corresponds to the number of cable bushings 7 which are required to operate the wet-rotor motor 2. Each of the openings 6, as can be seen from FIG. 4, has a section 43 with a reduced inner diameter and a section 42 with an increased inner diameter.

A terminal box 28, into which the cable bushings 7 open, is arranged on the bushing arrangement 4. In the terminal box 28, in each case one support 29 is positioned for the mechanical decoupling of the so-called conductive expansion connector 30. The supports 29 are designed in this exemplary embodiment as epoxy resin insulators.

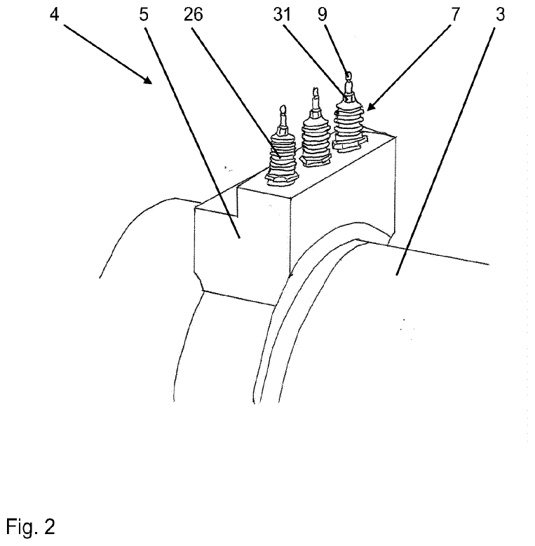

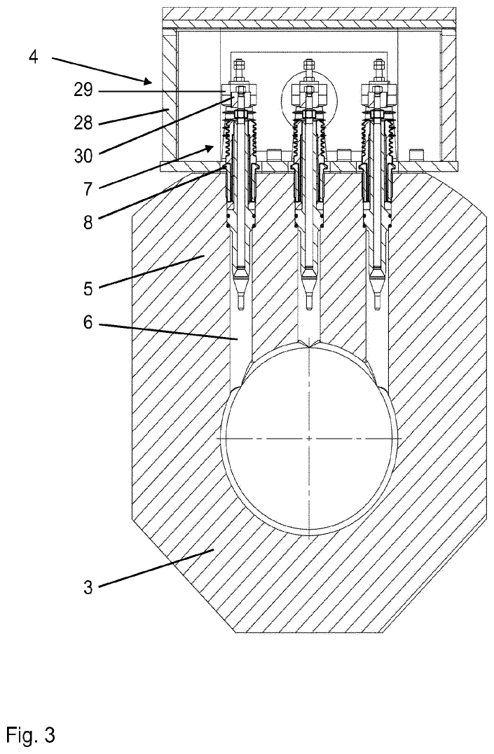

FIG. 2 shows a perspective illustration of a bushing arrangement 4 with three cable bushings 7. In conjunction with FIG. 3, it is evident that the cable bushings are arranged fixedly in the openings 6 of the part 5 of the motor housing 3 by means of in each case one holding element 8. An outer insulating body 26 covers the holding element 8. To this end, the outer insulating body 26 is plugged on an inner insulating body 10 and is fixed at the top by way of a washer 32 and a nut 31.

The holding element 8 is designed as a non-magnetic threaded bushing, for example with an M64 external thread. In the exemplary embodiment shown, the terminal box 28 is seated directly on the collar-shaped elevation of the part 5 of the motor housing 3. The three cable bushings 7 open into the terminal box 28, and each have a connection to the conductive expansion connector 30, which in turn is connected to in each case one support 29 for mechanical decoupling.

FIG. 4 shows a detailed cross-sectional illustration of the cable bushing 7. The cable bushing 7 comprises a guide body 9, which has a rod-shaped part 11 and a double cone 12. The double cone 12 realizes the conical surfaces of the guide body 9, which are formed as partial surfaces of a straight circular cone. The guide body 9 is largely formed as an elongate, cylindrical rod, at the end of which, at reference numeral 44, a connection (not shown) to the plastic-insulated copper wire 27 of the stator winding 24 is arranged. The conical surfaces of the guide body 9 interact with the conical surfaces of the insulating body 10 and form a corresponding pair of active surfaces 41.

The insulating body 10 is formed from polyether ether ketone (PEEK) and shrink fitted onto the guide body 9. Here, the shrinkable composite extends at least over half the length of the rod-shaped part 11 of the guide body 9 and ends at the transition to the double cone 12. Due to the shrink fitting on the double cone 12, the composite of the insulating body 10 and the guide body 9 is significantly less mechanically loaded and is thus more durable in operation.

The insulating body 10 has a metallization in the form of a substituted nickel layer, which is applied in the inner hollow cylinder of the insulating body 10. As a result, a reproducible conductivity is achieved by a defined layer thickness.

The cable bushing 7 has a further, outer insulating body 26 and is positioned over the shrink fitted insulating body 10 and within the non-magnetic threaded bushing 8, which fixes the cable bushing 7 in the opening 6 of the housing 3. The outer insulating body 26 is adjusted at the upper end by way of a washer 32 and a nut 31. The threaded bushing 8 is designed with an external thread. The spacer sleeve 46 is made of PEEK and positions the field control element 45.

A thickened portion 33 is arranged in the central part of the insulating body 10, which thickened part is formed as the seat of the cable bushing 7 within the opening 6 of the housing 3. To this end, the thickened portion 33 has a first recess or chamfer 34 in the region of the section 42 of the opening 6 of the housing 3 for implementing a first O-ring 35, which assumes the task of sealing the cable bushing 7 in the opening 6 of the housing 3.

In addition, the thickened portion 33 of the insulating body 10 has a second recess 36 in the form of a radially circumferential groove in the middle of the thickened portion 33, in which a second O-ring 37 can be implemented for sealing. This second O-ring 37 is advantageously provided as a redundant seal of the cable bushing 7 in the opening 6 of the housing 3. In an unfavorable emergency, in which the very high pressure is also accompanied by an increased temperature, after the loss of the sealing effect of the first O-ring 35, the second O-ring 37 can maintain the sealing effect.

The thickened portion 33 has a seat for a ring 38 on the side facing away from the first O-ring 35, which ring is designed as a rupture protection means. This ring 38 is designed as a metal ring. The metal ring is preferably formed as a brass ring or as a ring of non-magnetic iron. In the case of a so-called rupture, that is to say the insulating body 10 breaks and the guide body 9 is pressed out of the cable bushing 7, the ring 38 for the rupture protection in combination with the double cone 12 of the guide body 9 prevents an exit from the insulating body 10.

In addition, at the transition of the conical surfaces of the insulating body 10 and the guide body 9, a sealing third O-ring 39 is embedded in the guide body 9, such that there is a redundant safeguard against a fluid outlet, should the conical surfaces of the insulating body 10 suffer damage to the connection on the conical surfaces of the guide body 9.

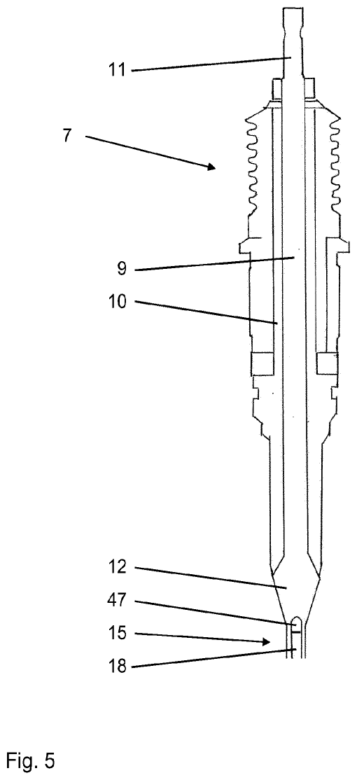

FIG. 5 shows a detailed illustration of the cable bushing 7, in particular of the connection 15, which is designed as a press or crimp connection. The guide body 9 has an extension, which is formed as a hollow cylinder 47. The cylindrical wire end 18 of the conducting wire 27 is introduced into the hollow cylinder 47, and is incorporated by way of a pressing tool to form a non-positive connection 15.

The conducting wire 27, including the cylindrical wire end 18 and the extension of the guide body 9 are made of copper. The copper-based crimp connection provides excellent and almost loss-free conductivity.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-14. (canceled)

15. An apparatus comprising:
a pump unit with a pump which is driven by a wet-rotor motor, wherein
the wet-rotor motor is surrounded by a motor housing and has a stator winding,
the motor housing comprises a bushing arrangement for supplying power to the stator winding of the wet-rotor motor, and the bushing arrangement has, on a part of the motor housing, openings into which in each case one cable bushing is fixed with the aid of a holding element,
each cable bushing has a guide body and an insulating body,
the guide body and the stator winding have a connection, and
the connection is formed as a press connection.

16. The apparatus according to claim 15, wherein the guide body has an extension which is formed as a hollow cylinder.

17. The apparatus according to claim 15, wherein the stator winding has at least one wire end which is inserted into the hollow cylinder.

18. The apparatus according to claim 16, wherein the hollow cylinder and the wire end have a non-positive connection.

19. The apparatus according to claim 15, wherein the connection at least partially comprises at least four, preferably at least six, outer surfaces, wherein two outer surfaces are each arranged opposite each other.

20. The apparatus according to claim 15, wherein the insulating body has at least partially conical surfaces which interact with the guide body.

21. The apparatus according to claim 15, wherein the guide body has at least partially conical surfaces.

22. The apparatus according to claim 15, wherein the guide body comprises a rod-shaped part and a part in the form of a double cone.

23. The apparatus according to claim 15, wherein the insulating body is of shrink-fitted configuration on the guide body.

24. The apparatus according to claim 15, wherein the insulating body is made of a high-performance plastic.

25. The apparatus according to claim 15, wherein the insulating body has a metallization.

26. The apparatus according to claim 15, wherein the cable bushing has a field-control element.

27. A method comprising:
producing a pump which is driven by a wet-rotor motor,
wherein a bushing arrangement for supplying power to the wet-rotor motor comprises a cable bushing which comprises a guide body and an insulating body,
wherein a wire end of the stator winding is inserted into the hollow cylinder of the guide body for each cable bushing, and a positively locking connection is established with the aid of a pressing tool.

28. A method comprising:
providing the pump according to claim 15; and
using the pump unit with the pump in a power-plant circuit with high system pressure to seal the power supply of the wet-rotor motor against high system pressure with the aid of a cable bushing.
